(19) United States
(12) Patent Application Publication
(10) Pub. No.: US 2011/0037439 A1
(43) Pub. Date: Feb. 17, 2011

(54) INCREASING ENERGY DENSITY IN RECHARGEABLE LITHIUM BATTERY CELLS

(75) Inventors: Ramesh C. Bhardwaj, Fremont, CA (US); Taisup Hwang, Santa Clara, CA (US)

Correspondence Address: PVF -- APPLE INC.;c/o PARK, VAUGHAN, FLEMING & DOWLER LLP, 2820 FIFTH STREET, DAVIS, CA, 95618-7759, US

(73) Assignee: APPLE INC., Cupertino, CA (US)

(21) Appl. No.: 12/564,816

(22) Filed: Sep. 22, 2009

Related U.S. Application Data
(63) Continuation-in-part of application No. 12/542,411, filed on Aug. 17, 2009.

(51) Int. Cl. H02J 7/04; H01M 2/16

(52) U.S. Cl. 320/152; 320/162; 320/157; 429/246; 429/218.1

(57) ABSTRACT

Some embodiments of the present invention provide an improved rechargeable lithium battery. This rechargeable lithium battery includes a cathode current collector with a coating of cathode active material. It also includes an electrolyte separator, and an anode current collector with a coating of anode active material. Within this rechargeable battery, the thickness of the coating of cathode active material and the thickness of the coating of anode active material are selected so that the battery will charge in a predetermined maximum charging time with a predetermined minimum cycle life when the battery is charged using a multi-step constant-current constant-voltage (CC-CV) charging technique. Note that using the multi-step CC-CV charging technique instead of a conventional charging technique allows the thickness of the cathode active material and the thickness of the anode active material to be increased while maintaining the same predetermined maximum charging time and the same predetermined minimum cycle life. This increase in the thickness of the active materials effectively increases both the volumetric and gravimetric energy density of the battery cell.

### RELATED APPLICATION

This application is a continuation-in-part of, and hereby claims priority under 35 U.S.C. §120 to, pending U.S. patent application Ser. No. 12/542,411, entitled “Modulated Temperature-Based Multi-CC-CV Charging Technique for Li-ion/Li-Polymer Batteries,” filed on 17 Aug. 2009 by inventors Ramesh C. Bhardwaj, Taisup Hwang and Richard M. Mank (Attorney Docket No. APL-P7497US1).

### BACKGROUND

1. Field

The present invention generally relates to techniques for charging rechargeable batteries. More specifically, the present invention relates to a new battery-charging technique that facilitates increasing the energy density of a lithium-ion or lithium-polymer battery cell.

2. Related Art

Rechargeable batteries are presently used to provide power to a wide variety of portable electronic devices, including laptop computers, cell phones, PDAs, digital music players and cordless power tools. As these electronic devices become increasingly smaller and more powerful, the batteries which are used to power these devices need to store more energy in a smaller volume.

The most commonly used type of rechargeable battery is a lithium battery, which can include a lithium-ion or a lithium-polymer battery. Lithium-ion and lithium-polymer battery cells typically contain a cathode current collector; a cathode coating comprised of an active material, a separator, an anode current collector; and an anode coating comprised of an active material. The conventional technique for increasing the energy capacity (mAh) of a lithium-ion or a lithium-polymer battery cell involves increasing the lengths of the anode and cathode current collectors, and additionally increasing the lengths of their respective coating materials, wherein both the thickness of these coating materials and the charge-current density for the current collectors (mA/cm²) remain same.

However, note that increasing the area of these current collectors results in the same or lower volumetric energy density (Wh/L) as the cell capacity increases. Hence, the battery becomes larger, which is not practical for many portable electronic devices.

Hence, what is needed is a technique for increasing the energy capacity of a rechargeable lithium battery cell without increasing the size of the battery cell.

### SUMMARY

Some embodiments of the present invention provide an improved rechargeable lithium battery. This rechargeable lithium battery includes a cathode current collector with a coating of cathode active material. It also includes an electrolyte separator, and an anode current collector with a coating of anode active material. Within this rechargeable battery, the thickness of the coating of cathode active material and the thickness of the coating of anode active material are selected so that the battery will charge in a predetermined maximum charging time with a predetermined minimum cycle life when the battery is charged using a multi-step constant-current constant-voltage (CC-CV) charging technique. Note that using the multi-step CC-CV charging technique instead of a conventional charging technique allows the thickness of the cathode active material and the thickness of the anode active material to be increased while maintaining the same predetermined maximum charging time and the same predetermined minimum cycle life. This increase in the thickness of the active materials effectively increases both the volumetric and gravimetric energy density of the battery cell.

In some embodiments, an initial charge-current density for the multi-step CC-CV charging technique exceeds an initial charge-current density for a single step CC-CV charging technique that achieves the same predetermined minimum cycle life.

In some embodiments, the initial charge-current density for the multi-step CC-CV charging technique exceeds 2.5 mA/cm².

In some embodiments, the cathode current collector is comprised of aluminum; the coating of cathode active material is comprised of LiCoO₂; the anode current collector is comprised of copper; the coating of anode active material is comprised of graphite; and the electrolyte separator is comprised of polyethylene or polypropylene.

In some embodiments, the cathode has a first surface and a second surface which are coated with the cathode active material. Similarly, the anode has a first surface and a second surface which are covered with the anode active material. Additionally, the electrolyte separator includes: a first electrolyte separator located between the first surface of the cathode and the second surface of the anode; and a second electrolyte separator located between the second surface of the cathode and the first surface of the anode.

Other embodiments of the present invention provide a method for charging a battery using a multi-step constant-current constant-voltage (CC-CV) charging technique. Under this technique, the system first obtains a set of charge currents {I₁, . . . , Iₙ} and a set of charging voltages {V₁, . . . , Vₙ}. Next, the system repeats a series of constant-current and constant-voltage charging steps, starting with i=1 and incrementing i with every repetition, until a termination condition is reached. These constant-current and constant-voltage charging steps include: charging the battery using a constant current Iᵢ until a cell voltage of the battery reaches Vᵢ; and then charging the battery using a constant voltage Vᵢ until a charge current is less than or equal to Iᵢ₊₁. By using this multi-step CC-CV charging technique, the battery charges in a predetermined maximum charging time with a predetermined minimum cycle life. Moreover, an initial charge-current density associated with the initial charge current I₁ exceeds an initial charge-current density for a single-step CC-CV charging technique that achieves the same predetermined minimum cycle life.

In some embodiments, the set of charge currents and the set of charging voltages are obtained by looking up the set of charge currents and the set of charging voltages in a lookup table based on a measured temperature of the battery.

In some embodiments, the termination condition is reached when the charge current Iᵢ equals a terminal charge current Iₜₑᵣₘ.

### COLOR DRAWINGS

The patent or application file contains at least one drawing executed in color. Copies of this patent or patent application publication with color drawing(s) will be provided by the Office upon request and payment of the necessary fee.

### BRIEF DESCRIPTION OF THE FIGURES

This specification contains at least one drawing executed in color. Copies of this patent or patent application publication with color drawing(s) will be provided by the Office upon request and payment of the necessary fee.

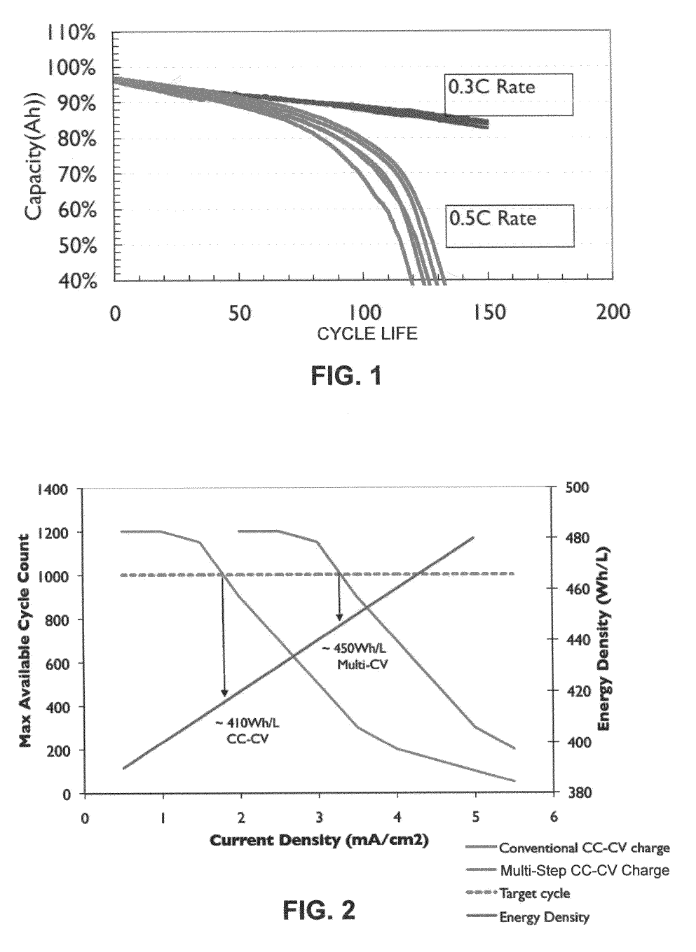

FIG. 1 illustrates how battery cycle life is affected by charge current in accordance with an embodiment of the present invention.

FIG. 2 illustrates how battery cycle life is affected by charge-current density in accordance with an embodiment of the present invention.

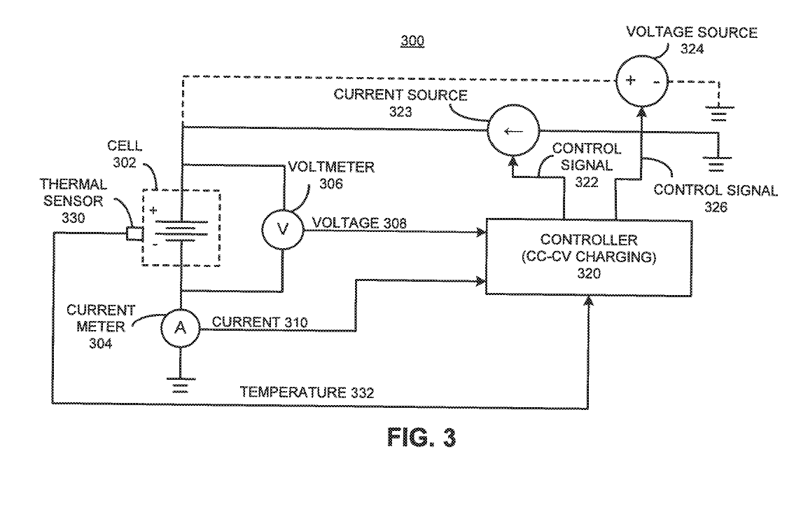

FIG. 3 illustrates a system for charging a battery using a CC-CV charging technique in accordance with an embodiment of the present invention.

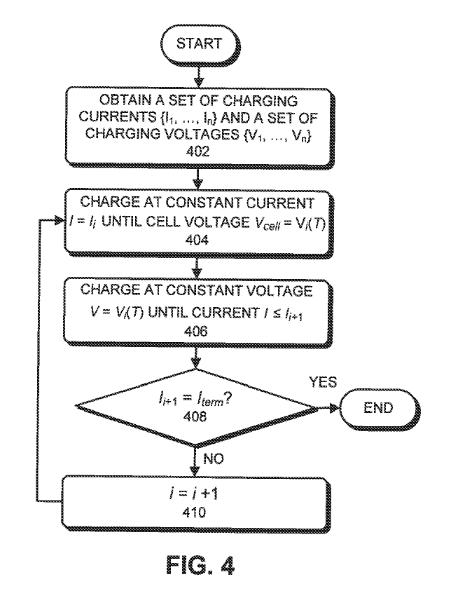

FIG. 4 presents a flow chart illustrating operations involved in a multi-step CC-CV charging technique in accordance with an embodiment of the present invention.

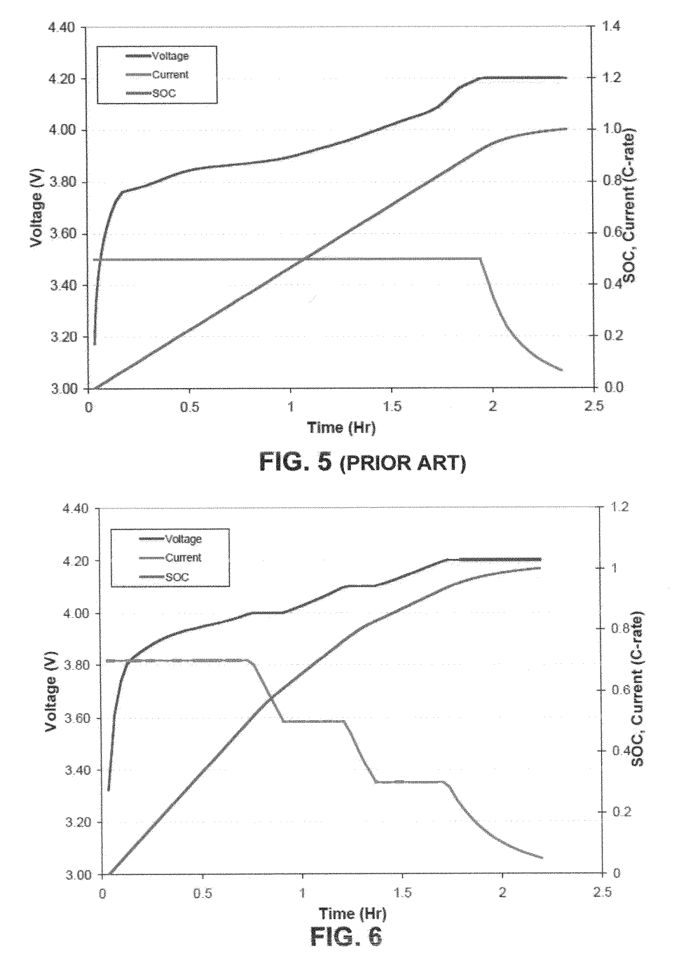

FIG. 5 illustrates performance of a conventional single-step CC-CV charging technique.

FIG. 6 illustrates performance of a multi-step CC-CV charging technique in accordance with an embodiment of the present invention.

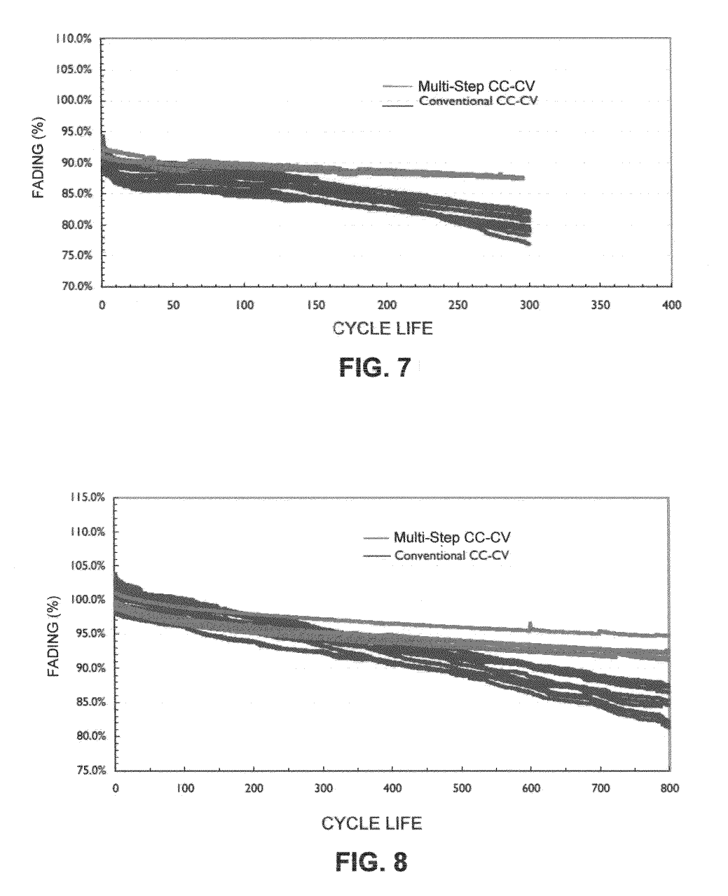

FIG. 7 illustrates how batteries fade with cycle life under both conventional and multi-step CC-CV charging techniques at 23° C. in accordance with an embodiment of the present invention.

FIG. 8 illustrates how batteries fade with cycle life under both conventional and multi-step CC-CV charging techniques at 10° C. in accordance with an embodiment of the present invention.

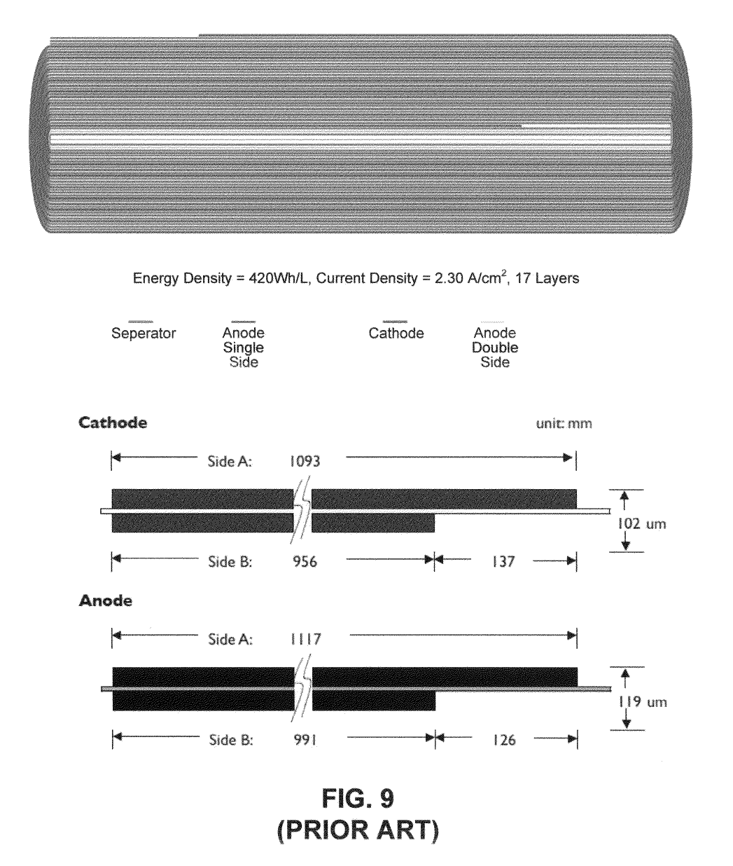

FIG. 9 illustrates the structure of a conventional battery cell.

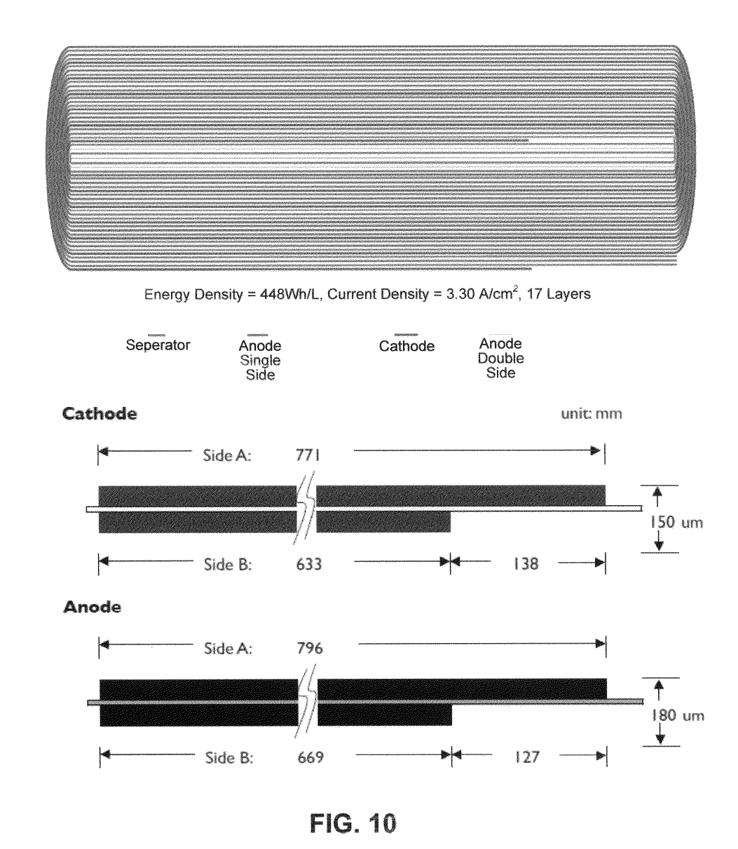

FIG. 10 illustrates the structure of a new battery cell which has thicker cathode and anode coatings and uses a multi-step CC-CV charging technique in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

This present invention increases both the volumetric and gravimetric energy density (Wh/L) of a rechargeable lithium battery cell. This increase in energy density facilitates making battery cells smaller, which allows the limited space available in portable electronic devices to be used more efficiently. For example, the space savings can be used to incorporate additional features into the electronic device, or to provide more battery capacity, which increases battery run time.

The basic idea behind the present invention is simple. Battery capacity is increased by increasing the thicknesses of active-material coatings on both the anode and cathode current collectors without increasing the length and width of the associated current collectors or the separator. Note that the separator, the anode current collector and the cathode current collector are non-active components in the battery cell. Hence, increasing the surface area of these components does not increase the gravimetric or volumetric energy density of the battery cell.

The present invention increases the energy density of a battery cell by increasing the thickness of active material coatings on both the cathode and the anode and also decreasing the area of inactive materials. This is accomplished without decreasing the cycle life of the battery by using a new multi-step CC-CV charging technique which reduces current densities as the battery cell reaches a higher state of charge (SOC), for example between 70 and 100% SOC.

Note that if the coating thickness is increased, the charge-current density must be increased to charge the battery in the same amount of time. Unfortunately, charge-current density is inversely proportional to cycle life for lithium-ion and lithium-polymer battery cells. Also note that using the same charge-current density at different temperatures also affects cycle life. For example, maintaining the same charge-current density at a lower temperature (10° C.) will lower the cycle life of lithium-ion/lithium-polymer battery substantially as compared to a higher temperature (45° C.).

FIG. 1 presents a graph of empirical results which illustrate how battery cycle life is affected by charge current. This graph compares the cycle life of a battery cell charged using the 0.3 C rate (0.82 A) versus the 0.5 C rate (1.37 A) at 10° C. As indicated by this graph, charging the battery cell using a 0.5 C rate reduces the cycle life as compared to a 0.3 C rate. Similar results can be obtained at other temperatures.

Charge current can easily be translated into charge-current density (mA/cm²) by dividing the cathode area by the charge current. The charge-current density in most lithium-ion and lithium polymer battery cells varies between 2.2-2.5 mA/cm² because higher current densities reduce the battery's cycle life to unacceptably low levels. However, note that higher charge-current densities only make cycle life suffer at higher states of charge (SOC), for example between 70-100% SOC. Hence, if the charge currents can be reduced at higher states of charge (and at lower temperatures), the degradation in cycle life can be avoided (and cycle life can even be increased) without any change in battery chemistry.

A diagram illustrating differences between a conventional cell design and an improved cell/battery design is shown in FIG. 2, which illustrates relationships between cycle life, current density, and energy density. The conventional charging technique (labeled as “conventional CC-CV charge”) involves a single constant-current charging step, which involves, for example, charging at a 0.5 C rate until the battery voltage reaches 4.2V. This constant-current step is followed by a single constant-voltage charging step at 4.2V until the charge current drops to 0.05 C. (Note that this same conventional charging technique is used across a wide range of temperatures.)

In contrast, the new multi-step CC-CV charging technique (labeled as “multi CC-CV charge”) involves a series of constant-current and constant-voltage charging steps. For example, the system can charge at a higher initial constant current of 0.7 C until the battery reaches a 50% state of charge. Then, the system charges at a constant voltage until the charge current drops to 0.6 C. Next, the system can charge at a slightly lower constant current of 0.6 C until the battery reaches a 60% state of charge. The system can then repeat additional CC-CV steps until the battery is fully charged.

FIG. 2 illustrates how the new multi-step CC-CV charging technique can charge a battery cell with a higher initial current density while maintaining the same cycle life. This higher initial charge-current density enables a battery cell with thicker active material coatings to charge in the same amount of time as a conventional battery cell with thinner active material coatings, wherein this conventional battery cell uses a conventional single constant-current charging step followed by a single constant-voltage charging step.

### Charging System

FIG. 3 illustrates a rechargeable battery system 300, which uses a CC-CV charging technique in accordance with an embodiment of the present invention. More specifically, the rechargeable battery system 300 illustrated in FIG. 3 includes a battery cell 302, such as a lithium-ion battery cell or a lithium-polymer battery cell. It also includes a current meter (current sensor) 304, which measures a charge current applied to cell 302, and a voltmeter (voltage sensor) 306, which measures a voltage across cell 302. Rechargeable battery system 300 also includes a thermal sensor 330, which measures the temperature of battery cell 302. (Note that numerous possible designs for current meters, voltmeters and thermal sensors are well-known in the art.)

Rechargeable battery system 300 additionally includes a current source 323, which provides a controllable constant charge current (with a varying voltage), or alternatively, a voltage source 324, which provides a controllable constant charging voltage (with a varying current).

The charging process is controlled by a controller 320, which receives: a voltage signal 308 from voltmeter 306, a current signal 310 from current meter 304, and a temperature signal 332 from thermal sensor 330. These inputs are used to generate a control signal 322 for current source 323, or alternatively, a control signal 326 for voltage source 324.

Note that controller 320 can be implemented using either a combination of hardware and software or purely hardware. In one embodiment, controller 320 is implemented using a microcontroller, which includes a microprocessor that executes instructions which control the charging process.

The operation of controller 320 during the charging process is described in more detail below.

### Charging Process

FIG. 4 presents a flow chart illustrating operations involved in a CC-CV charging operation in accordance with an embodiment of the present invention. First, the system obtains a set of charge currents {I₁, . . . , Iₙ} and a set of charging voltages {V₁, . . . , Vₙ} (step 402). This can involve looking up the set of charge currents and the set of charging voltages in a lookup table based on a measured temperature of the battery and a battery type of the battery. As mentioned above, these lookup tables can be generated by performing experiments using a lithium reference electrode to determine how much current/voltage can be applied to the battery before lithium plating takes place.

Next, the system charges the battery cell at a constant current I=Iᵢ until the cell voltage V_{cell}=Vᵢ(T) (step 404). Then, the system charges at a constant voltage V=Vᵢ(T) until the charge current I≦Iᵢ₊₁ (step 406). The system next determines if Iᵢ₊₁ equals a terminal current Iₜₑᵣₘ (step 408). If so, the process is complete. Otherwise, the counter variable i is incremented, i=i+1 (step 410), and the process repeats.

Note that the initial charge-current density associated with the initial charge current I₁ exceeds the initial charge-current density for a single-step CC-CV charging technique that achieves the same predetermined minimum cycle life.

### Differences Between Charging Techniques

FIGS. 5 and 6 illustrate differences between a conventional single-step CC-CV charging technique and a new multi-step CC-CV charging technique. More specifically, FIG. 5 illustrates the voltage, current and state of charge (SOC) for a single-step CC-CV charging technique. This single-step charging technique first charges at a constant-current of 0.49 A (0.5 C rate) up to 4.2V (93% SOC), and then charges at a constant voltage of 4.2V until the current drops below 0.05 C, at which point the battery cell reaches 100% SOC.

In contrast, the multi-step CC-CV charging illustrated in FIG. 6 involves a series of constant-current and constant-voltage charging steps. Note that using a constant-current charging step with a large current facilitates faster charging, but also leads to polarization of the electrode as the battery's SOC increases. The subsequent constant-voltage charging step enables the electrode to recover from polarization, which allows lithium to diffuse inside the anode and further reduces current as SOC increases. Consequently, this new charging technique allows battery cells to be charged in same amount of time, but improves the cycle life by reducing the current density at higher states of charge.

FIG. 7 illustrates how batteries fade with cycle life under both conventional and multi-step CC-CV charging techniques at 23° C. in accordance with an embodiment of the present invention. FIG. 8 illustrates the same comparison at 10° C. in accordance with an embodiment of the present invention. In FIG. 7, at around 300 cycles there is a cross-over point where the battery which is charged using the new multi-step CC-CV charging technique begins to fade less than the battery charged using the conventional single-step CC-CV charging technique. Hence, using the multi-step CC-CV charging technique can prevent degradation in battery capacity and can extend the cycle life. In FIG. 8, the cross-over point for 10° C. occurs even earlier, at about 100 cycles. Note that the improved cycle life illustrated in FIGS. 7 and 8 is largely due to using a reduced charge-current density at higher SOC. These graphs also indicate that charge-current density can be increased while maintaining the same cycle life, or alternatively, cycle life can be increased without increasing the charge-current density.

### Battery Cell Structure

Exemplary battery cell structures are illustrated in FIGS. 9 and 10. More specifically, FIG. 9 illustrates a conventional battery cell with a thin coating of active material on the cathode and the anode which requires longer current collectors to increase battery capacity. In contrast, FIG. 10 illustrates an improved battery cell with shorter current collectors and a thicker active material coating. Although the length, width and thickness of this improved battery cell is the same as a conventional battery cell, the energy density is increased because more active material is present inside the cell rather than non-active material. For example, the improved battery cell illustrated in FIG. 10 has a 5% increase in energy density over the conventional battery cell illustrated in FIG. 9. Note that the coating thicknesses can be further increased so that current density can reach up to 3.5 mA/cm² or more without significantly sacrificing cycle life. This potentially results in a 6-15% increase in energy density (Wh/L).

Note that the conventional battery cell illustrated in FIG. 9 has 17 layers in its jelly roll, and is charged with a maximum current density of 2.3 mA/cm². In contrast, the new battery cell design illustrated in FIG. 10 has only 12 layers in its jelly roll and is charged with a maximum charge-current density of 3.3 mA/cm². This increase in the charge-current density and associated decrease in the number of layers effectively increases the energy density of the battery cell from 420 Wh/L to 448 Wh/L. (Note that these numbers are merely exemplary, and the same technique can be extended to achieve higher charge-current densities and higher energy densities for other battery cells.)

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A rechargeable battery, comprising:
a cathode including a cathode current collector with a coating of cathode active material;
an electrolyte separator; and
an anode including an anode current collector with a coating of anode active material;
wherein a thickness of the coating of cathode active material and a thickness of the coating of anode active material are selected so that the battery will charge in a predetermined maximum charging time with a predetermined minimum cycle life when the battery is charged using a multi-step constant-current constant-voltage (CC-CV) charging technique.

2. The rechargeable battery of claim 1, wherein an initial charge-current density for the multi-step CC-CV charging technique exceeds an initial charge-current density for a single step CC-CV charging technique that achieves the same predetermined minimum cycle life.

3. The rechargeable battery of claim 2, wherein the initial charge-current density for the multi-step CC-CV charging technique exceeds 2.5 mA/cm².

4. The rechargeable battery of claim 1,
wherein the cathode current collector is comprised of aluminum;
wherein the coating of cathode active material is comprised of LiCoO₂;
wherein the anode current collector is comprised of copper;
wherein the coating of anode active material is comprised of graphite; and
wherein the separator is comprised of polyethylene or polypropylene.

5. The rechargeable battery of claim 1,
wherein the cathode has a first surface and a second surface which are coated with the cathode active material;
wherein the anode has a first surface and a second surface which are covered with the anode active material; and
wherein the electrolyte separator includes:
a first electrolyte separator located between the first surface of the cathode and the second surface of the anode; and
a second electrolyte separator located between the second surface of the cathode and the first surface of the anode.

6. A method for charging a battery using a multi-step constant-current constant-voltage (CC-CV) charging technique, comprising:
obtaining a set of charge currents {I₁, . . . , Iₙ} and a set of charging voltages {V₁, . . . , Vₙ}; and
repeating constant-current and constant-voltage charging steps, starting with i=1 and incrementing i with every repetition, until a termination condition is reached, wherein the constant-current and constant-voltage charging steps include,
charging the battery using a constant current Iᵢ until a cell voltage of the battery reaches Vᵢ, and then
charging the battery using a constant voltage Vᵢ until a charge current is less than or equal to Iᵢ₊₁;
wherein under the multi-step CC-CV charging technique the battery charges in a predetermined maximum charging time with a predetermined minimum cycle life; and
wherein an initial charge-current density associated with the initial charge current I₁ exceeds an initial charge-current density for a single-step CC-CV charging technique that achieves the same predetermined minimum cycle life.

7. The method of claim 6, wherein the initial charge-current density for the multi-step CC-CV charging technique exceeds 2.5 mA/cm².

8. The method of claim 6, wherein obtaining the set of charge currents and the set of charging voltages involves looking up the set of charge currents and the set of charging voltages in a lookup table based on a measured temperature of the battery.

9. The method of claim 6, wherein the termination condition is reached when the charge current Iᵢ equals a terminal charge current Iₜₑᵣₘ.

10. The method of claim 6, wherein the battery is a rechargeable lithium battery.

11. The method of claim 10, wherein the rechargeable lithium battery includes:
a cathode including a cathode current collector with a coating of cathode active material;
an electrolyte separator; and
an anode including an anode current collector with a coating of anode active material;
wherein a thickness of the coating of cathode active material and a thickness of the coating of anode active material are selected so that the battery will charge in the predetermined maximum charging time with a predetermined minimum cycle life when the battery is charged using the multi-step constant-current constant-voltage (CC-CV) charging technique.

12. A battery system with a charging mechanism, comprising:
a battery;
a voltage sensor configured to monitor a cell voltage of the battery;
a current sensor configured to monitor a charge current for the battery;
a charging source configured to apply a charge current and a charging voltage to the battery; and
a controller configured to receive inputs from the voltage sensor and the current sensor, and to send a control signal to the charging source, wherein the controller is configured to use a set of charge currents {I₁, . . . , Iₙ} and a set of charging voltages {V₁, . . . , Vₙ} to charge the battery;
wherein the controller is configured to perform a multi-step constant-current constant-voltage (CC-CV) charging operation which repeats constant-current and constant-voltage charging steps using the set of charge currents and the set of charging voltages until a termination condition is reached;
wherein under the multi-step CC-CV charging technique the battery charges in a predetermined maximum charging time with a predetermined minimum cycle life; and
wherein an initial charge-current density associated with the initial charge current I₁ exceeds an initial charge-current density for a single-step CC-CV charging technique that achieves the same predetermined minimum cycle life.

13. The battery system of claim 12, wherein repeating the constant-current and constant-voltage charging steps involves repeating the following steps starting with i=1:
charging the battery using a constant current Iᵢ until the cell voltage of the battery reaches Vᵢ;
charging the battery using a constant voltage Vᵢ until the charge current is less than or equal to Iᵢ₊₁; and
incrementing i.

14. The battery system of claim 12, further comprising a temperature sensor configured to measure a temperature of the battery; and
wherein the controller is configured to use the measured temperature to look up the set of charge currents and the set of charging voltages in a lookup table.

15. The battery system of claim 12, wherein the termination condition is reached when the charge current Iᵢ equals a terminal charge current Iₜₑᵣₘ.

16. The battery system of claim 12, wherein the battery is a rechargeable lithium battery.

17. The system of claim 12, wherein the initial charge-current density for the multi-step CC-CV charging technique exceeds 2.5 mA/cm².

18. The battery system of claim 12, wherein the battery includes:
a cathode including a cathode current collector with a coating of cathode active material;
an electrolyte separator; and
an anode including an anode current collector with a coating of anode active material;
wherein a thickness of the coating of cathode active material and a thickness of the coating of anode active material are selected so that the battery will charge in a predetermined maximum charging time with a predetermined minimum cycle life when the battery is charged using the multi-step constant-current constant-voltage (CC-CV) charging technique.

19. The battery system of claim 18,
wherein the cathode current collector is comprised of aluminum;
wherein the cathode active material is comprised of LiCoO₂;
wherein the anode current collector is comprised of copper;
wherein the anode active material is comprised of graphite; and
wherein the separator is comprised of polyethylene or polypropylene.

20. The battery system of claim 12,
wherein the cathode has a first surface and a second surface which are coated with the cathode active material;
wherein the anode has a first surface and a second surface which are covered with the anode active material; and
wherein the electrolyte separator includes:
a first electrolyte separator located between the first surface of the cathode and the second surface of the anode; and
a second electrolyte separator located between the second surface of the cathode and the first surface of the anode.

21. A charging mechanism for a battery, comprising:
a voltage sensor configured to monitor a cell voltage of the battery;
a current sensor configured to monitor a charge current for the battery;
a temperature sensor configured to measure a temperature of the battery;
a charging source configured to apply a charge current and a charging voltage to the battery; and
a controller configured to receive inputs from the voltage sensor, the current sensor and the temperature sensor, and to send a control signal to the charging source, wherein the controller is configured to look up a set of charge currents {I₁, . . . , Iₙ} and a set of charging voltages {V₁, . . . , Vₙ} in a lookup table based on the measured temperature; and
wherein the controller is configured to perform a multi-step constant-current constant-voltage (CC-CV) charging operation which repeats constant-current and constant voltage charging steps using the set of charge currents and the set of charging voltages until a termination condition is reached;
wherein under the multi-step CC-CV charging technique the battery charges in a predetermined maximum charging time with a predetermined minimum cycle life; and
wherein an initial charge-current density associated with the initial charge current I₁ exceeds an initial charge-current density for a single-step CC-CV charging technique that achieves the same predetermined minimum cycle life.
